(19) United States
(12) Patent Application Publication
(10) Pub. No.: US 2009/0224910 A1
(43) Pub. Date: Sep. 10, 2009

(54) Terminal device, management server and communication management system

(75) Inventor: Masato Nonaka, Tokyo (JP)

Correspondence Address: Moss & Burke, PLLC, 401 Holland Lane, Suite 407, Alexandria, VA, 22314, US

(73) Assignee: Oki Electric Industry Co., Ltd., Minato-ku (JP)

(21) Appl. No.: 12/314,874

(22) Filed: Dec. 18, 2008

(30) Foreign Application Priority Data
Mar. 4, 2008 (JP) 2008-053546

(51) Int. Cl. G08B 1/08; G06F 15/173

(52) U.S. Cl. 340/540; 709/223

(57) ABSTRACT

Plural terminal devices that are connected to each other via a network each include a work rhythm detection section, a communication control section and a communication determination section. The work rhythm detection section detects a work rhythm of a user based on a usage condition of the terminal device. The communication control section compares the detected work rhythm and a standard work rhythm serving as a standard of the work rhythm of the user and calculates a communication control value indicating a propriety of communication among the terminal devices. The communication determination section determines whether or not to carry out notification of a communication request from another terminal device based on the communication control value.

### CROSS-REFERENCE TO RELATED APPLICATIONS

This application claims priority under 35 USC 119 from Japanese Patent Application No. 2008-053546, the disclosure of which is incorporated by reference herein.

### BACKGROUND OF THE INVENTION

1. Field of the Invention

The present invention relates to a terminal device, a management server and a communication management system.

2. Description of the Related Art

Expectations with respect to telework are increasing based on social demands such as adaptation to various lifestyles, child-rearing assistance and improvement in the intellectual productivity of office workers. Further, with the development of information communication technologies, such as broadband capability increases and cost reductions of networks and processing capability improvement of computers, as a backdrop, various technologies for realizing telework are being developed, such as teleconferencing systems having a realistic feeling and office construction in virtual space.

At present, in the promotion of telework, problems are being pointed out with respect to working at home, such as in that communication with others can easily become rare, and in that mixing of working time periods and daily living time periods cannot be avoided. With these problems as a backdrop, it is considered that there are reductions in communication, and especially reductions in informal communication, among workers due to telework. As a result, technologies that assist communication among teleworkers have been proposed.

For example, Japanese Patent Application Laid-Open (JP-A) No. 2001-160959 discloses a method of recognizing the status of a teleworker utilizing a camera or a microphone, inducing the teleworker to a virtual refreshment room provided on a network in a case where a predetermined condition is met, and prompting conversation or chat with other teleworkers. Further, JP-A No. 2001-142850 discloses a method of inducing a teleworker to a refreshment room by showing break information of other teleworkers at a terminal that the teleworker is using. Furthermore, JP-A No. 2002-351805 discloses a method of making it possible to ascertain the conditions of other teleworkers by showing a teleworker behavioral conditions of other teleworkers to allow communication among teleworkers to be carried out smoothly.

In this manner, in the conventional art, the status of a teleworker is recognized to encourage breaks for the purpose of promoting communication among teleworkers. For example, informal communication is encouraged, and statuses of other teleworkers are shown to provide opportunities for communication.

### SUMMARY OF THE INVENTION

The present invention has been made in view of the above circumstances and provides a terminal device, a management server and a communication management system.

According to a first aspect of the invention, there is provided a terminal device, plural terminal devices being connected to each other via a communication network, the terminal device comprising: a work rhythm detection section that detects a work rhythm of a user based on a usage condition of the terminal device; a communication control section that compares the detected work rhythm and a standard work rhythm serving as a standard of the work rhythm of the user and calculates a communication control value indicating a propriety of communication among the terminal devices; and a communication determination section that determines whether or not to carry out notification of a communication request from another terminal device based on the communication control value.

According to a second aspect of the invention, there is provided a management server that is connected to plural terminal devices via a communication network and manages communication among the terminal devices, the management server comprising: a work rhythm input section to which work rhythms of users, which are detected based on usage conditions of the respective corresponding terminal devices, are input from the respective terminal devices; a communication control section that compares the input work rhythms and a standard work rhythm serving as a standard of the work rhythms of the users and calculates a communication control value indicating a propriety of communication among the terminal devices; and a communication determination section that determines whether or not to carry out notification of a communication request to a terminal device for which communication has been requested from another terminal device, based on the communication control value.

According to a third aspect of the invention, there is provided a communication management system in which plural terminal devices and a management server that manages communication among the plural terminal devices are connected via a communication network, each terminal device comprising: a work rhythm detection section that detects a work rhythm of a user based on a usage condition of the terminal device; and a work rhythm output section that outputs the detected work rhythm to the management server, the management server comprising: a work rhythm input section to which the work rhythms are input from the respective terminal devices; a communication control section that compares the input work rhythms and a standard work rhythm serving as a standard of the work rhythms of the users and calculates a communication control value indicating a propriety of communication among the terminal devices; and a communication determination section that determines whether or not to carry out notification of a communication request to a terminal device for which communication has been requested from another terminal device, based on the communication control value.

### BRIEF DESCRIPTION OF THE DRAWINGS

Preferred embodiments of the present invention will be described in detail based on the following figures, wherein:

FIG. 1 is an explanatory view showing an outline configuration of a communication management system according to a first exemplary embodiment of the present invention;

FIG. 2 is a block diagram showing the configuration of the communication management system according to the same exemplary embodiment;

FIG. 3 is an explanatory view showing a communication control value according to the same exemplary embodiment;

FIG. 4 is a flowchart showing communication control processing according to the same exemplary embodiment;

FIG. 5 is a block diagram showing a configuration of a communication management system according to a second exemplary embodiment of the present invention;

FIG. 6 is an explanatory view showing a communication control value according to the same exemplary embodiment; and

FIG. 7 is a block diagram showing a configuration of a communication management system according to a third exemplary embodiment of the present invention.

### DETAILED DESCRIPTION OF THE INVENTION

In the conventional methods described above, the occurrence of an opportunity for communication is dependent on the status of another teleworker, and it is not necessarily the case that communication can be carried out at a timing that is desired by the teleworker.

In this regard, in knowledge creation work, there are portions which involve thinking in a concentrated manner and portions which involve communication with others. In an ordinary office, since workers are present at the same time and at the same place, a rhythm according to which work is carried out (hereinafter, referred to as a “work rhythm”), involving time periods for concentrating and time periods for relaxing, is naturally formed. In this work rhythm, the work rhythms of respective workers are synchronized with each other. For example, although it is busy during certain times, after these certain times, a relaxed atmosphere ensues. Further, before an important meeting, there is a sense of tension, but after the meeting, there is a sense of relief.

On the other hand, in telework, since teleworkers work so as to match their own lifestyles, it is difficult to apply the concept of working hours thereto. Further, since the locations of the teleworkers are separated from each other, it is difficult to understand the conditions of other teleworkers, in comparison with the case of office work. Accordingly, unlike ordinary office work, there is a tendency for respective teleworkers to work according to different work rhythms. As a result, there is a problem in that time periods for concentrating and time periods for relaxing, of respective teleworkers, do not coincide, and communication among teleworkers is difficult to carry out. This tendency is manifested particularly strongly for informal communication due to the lack of necessity thereof.

The problem in question arises from the fact that the work rhythms of respective workers are not synchronized. The conventional art does not actively synchronize the work rhythms of the teleworkers and is not sufficient from the standpoint of assisting communication.

The present invention has been achieved in consideration of the aforementioned problems and provides a terminal device, a management server and a communication management system in which it is possible to control communication among teleworkers to synchronize the work rhythms of the respective teleworkers.

Hereinafter, preferred exemplary embodiments of the present invention will be explained in detail with reference to the attached drawings. It should be noted that, in the present specification and the drawings, for constituent elements having substantially the same functional configuration, overlapping explanation will be omitted by attaching the same reference numerals thereto.

### First Exemplary Embodiment

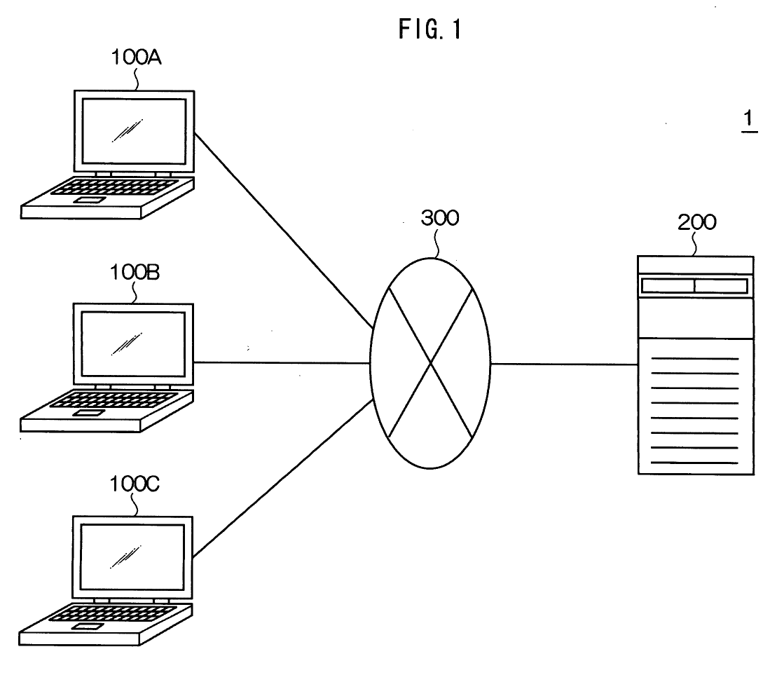

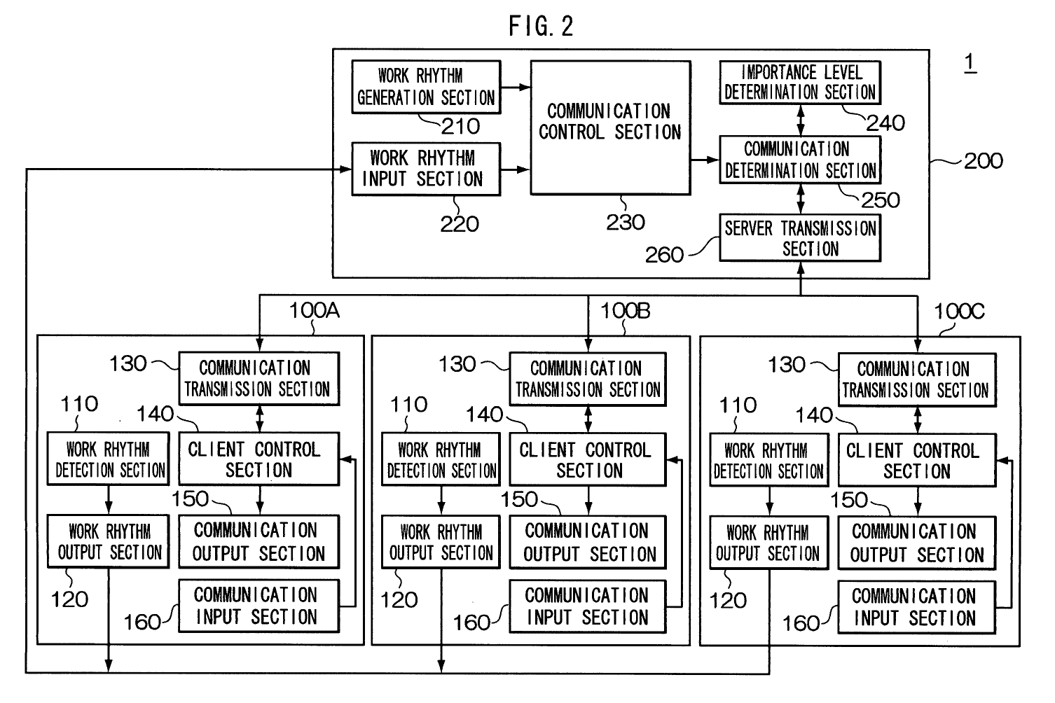

First, a configuration of a communication management system 1 according to a first exemplary embodiment of the present invention will be explained based on FIG. 1 and FIG. 2. It should be noted that FIG. 1 is an explanatory view showing an outline configuration of the communication management system 1 according to the present exemplary embodiment. FIG. 2 is a block diagram showing the configuration of the communication management system 1 according to the present exemplary embodiment.

As shown in FIG. 1, in the communication management system 1 according to the present exemplary embodiment, at least one terminal device 100 used by respective users (in the present exemplary embodiment, reference numerals 100A, 100B and 100C are attached in order to distinguish the respective terminal devices) is connected via a communication network 300 to a management server 200 that manages communication among the respective terminal devices 100. The terminal devices 100 are devices such as, for example, personal computers or the like, which teleworkers use at the time of carrying out work. These terminal devices 100 connected via the communication network 300 are capable of conducting communication among the terminal devices 100.

The management server 200 manages a propriety of communication carried out among the terminal devices 100 based on work rhythms of, for example, teleworkers which are the users, which are input from the respective terminal devices 100 via the communication network 300. The management server 200 determines whether or not to carry out notification of communication requests to the respective terminal devices 100 based on the results of determining the propriety of communication among the terminal devices 100. The communication management system 1 according to the present exemplary embodiment synchronizes the work rhythms of the teleworkers by controlling the communication of the teleworkers using the terminal devices 100, by the management server 200.

Next, configurations of the terminal devices 100 and the management server 200 constituting the communication management system 1 according to the present exemplary embodiment will be explained based on FIG. 2.

As shown in FIG. 2, the terminal device 100 is constituted from a work rhythm detection section 110, a work rhythm output section 120, a communication transmission (transmission/reception) section 130, a client control section 140, a communication output section 150 and a communication input section 160.

The work rhythm detection section 110 is a functional section that detects a work rhythm of a user using the terminal device 100. The work rhythm detection section 110 detects the work rhythm from an operational condition of the terminal device 100. A usage condition can be judged from, for example, a usage amount of an input section such as a keyboard, a mouse or the like, a type of an application that is being used, or the like. Alternatively, a working status of the teleworker can be photographed by an imaging device, and judgment can be carried out from the working status. The work rhythm detection section 110 detects the work rhythm of the user at a predetermined interval or a predetermined timing and outputs the detected work rhythm to the work rhythm output section 120. The work rhythm output section 120 outputs the work rhythm that has been input from the work rhythm detection section 110, to the management server 200.

The communication transmission section 130 is a functional section that sends and receives information concerning communication carried out among the terminal devices 100. When the teleworker requests communication with respect to a teleworker using another terminal device 100, the communication transmission section 130 sends a communication request that has been input from the client control section 140, which will be described below, to the management server 200. On the other hand, in a case where there is a communication request at one's own terminal device 100 from a teleworker using another terminal device 100, when the management server 200 has judged that communication is permitted, the communication request from the another terminal device 100 is sent from the management server 200 to the communication transmission section 130. Then, the communication transmission section 130 sends the received communication request from the another terminal device 100, to the client control section 140.

The client control section 140 is a functional section that controls sending and receiving of communication by a communication tool. The client control section 140 outputs the communication request to the another terminal device 100, which has been input from the communication input section 160 which will be described below, from the communication transmission section 130 to the management server 200. Further, at the client control section 140, the communication request from the another terminal device 100, which has been sent from the management server 200, is input from the communication transmission section 130. The communication request which has been input is output from the communication output section 150 which will be described below.

The communication output section 150 is a functional section that carries out notification of the communication request from the another terminal device 100 and the communication content, to the teleworker. For the communication output section 150, for example, a display, a speaker or the like can be used.

The communication input section 160 is a functional section for inputting the communication request and inputting the communication content in the case where the teleworker wishes to carry out communication with a teleworker using another terminal device 100. For the communication input section 160, for example, a keyboard, a mouse, a microphone or the like can be used.

As shown in FIG. 2, the management server 200 is constituted from a work rhythm generation section 210, a work rhythm input section 220, a communication control section 230, an importance level determination section 240, a communication determination section 250 and a server transmission (transmission/reception) section 260.

The work rhythm generation section 210 is a functional section that generates a standard work rhythm which is a work rhythm that serves as a standard. The work rhythm generation section 210 generates the standard work rhythm at a predetermined timing based on predetermined conditions which are set in advance, a history of the work rhythms of the respective teleworkers, or the like. In the communication management system 1 according to the present exemplary embodiment, control is carried out so as to synchronize the work rhythms of the respective teleworkers with the standard work rhythm. The standard work rhythm that has been generated by the work rhythm generation section 210 is output to the communication control section 230 which will be described below.

The work rhythm input section 220 is a functional section to which the work rhythms of the respective teleworkers are input. At the work rhythm input section 220, the work rhythm of the teleworker, which has been output from the work rhythm output section 120 of the terminal device 100, is input. Then, the work rhythm input section 220 outputs the input work rhythm to the communication control section 230.

The communication control section 230 is a functional section that controls communication among the terminal devices 100. The communication control section 230 compares the standard work rhythm that has been input from the work rhythm generation section 210 and the work rhythms of the respective teleworkers that have been input from the work rhythm input section 220 and calculates a communication control value indicating a propriety of communication among the terminal devices. Further, the communication control section 230 may be configured so as to carry out a setting change that changes the number of electronic mail notifications that are notified, based on the calculated communication control value. For example, a configuration can be provided in which, when communication is restricted, the number of electronic mail notifications that the teleworker is notified of is reduced or notification of electronic mail is not carried out. Further, a configuration can be provided in which, when communication is not restricted, the number of electronic mail notifications that the teleworker is notified of is not restricted. The calculated communication control value and the setting change information is output to the communication determination section 250 which will be described below.

The importance level determination section 240 is a functional section that determines an importance level of the communication. The importance level determination section 240 determines the importance level based on, for example, a communication tool or a communication content. In the present exemplary embodiment, the communication tool is a communication service such as, for example, telephone, electronic mail, chat or the like. Further, the communication content is the content that the teleworker is actually notified of, such as, for example, a subject, a mail body, a sender or the like, in the case of electronic mail. The importance level determination section 240 uses this information to determine whether or not the requested communication is important.

The communication determination section 250 is a functional section that determines a propriety of communication among the terminal devices. The communication determination section 250 determines whether or not to accept a communication request and carry out notification thereof to the teleworker based on the communication control value that has been input from the communication control section 230 and the importance level of the communication that has been input from the importance level determination section 240. The communication determination section 250 outputs the determination result to the server transmission section 260.

The server transmission section 260 is a functional section that carries out sending and receiving of the communication request and the communication content from the terminal devices 100. The server transmission section 260 provides a service such as, for example, delivering an electronic mail or connecting a telephone call to another terminal device 100 in accordance with a request from a certain terminal device 100. At this time, the server transmission section 260 carries out notification of the communication request and the communication content to the terminal device 100 based on the determination result of the communication determination section 250.

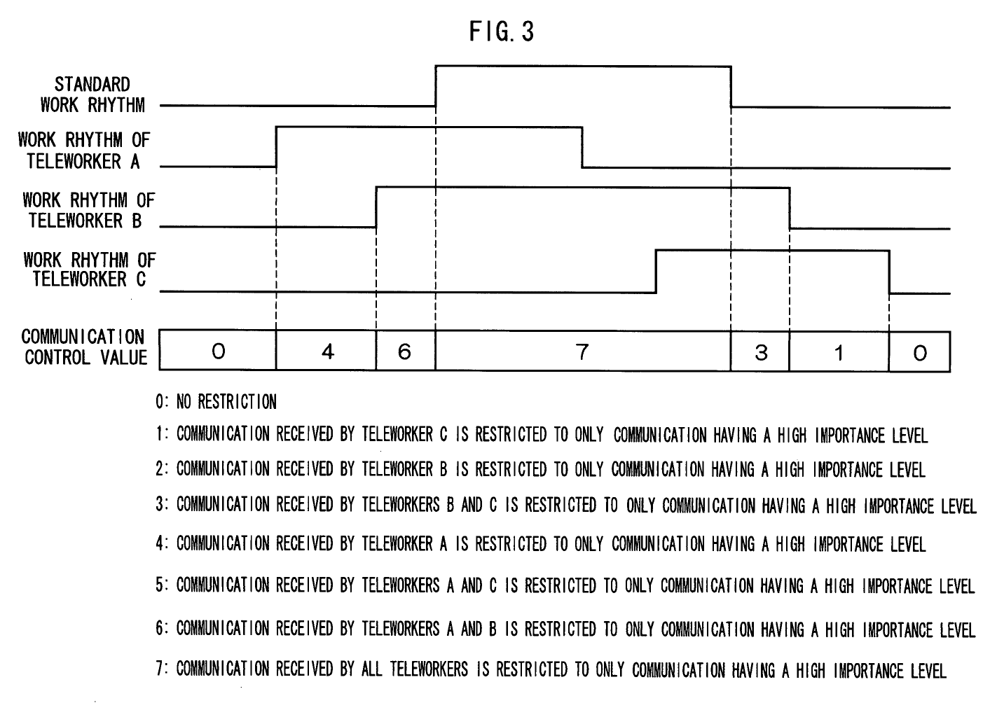

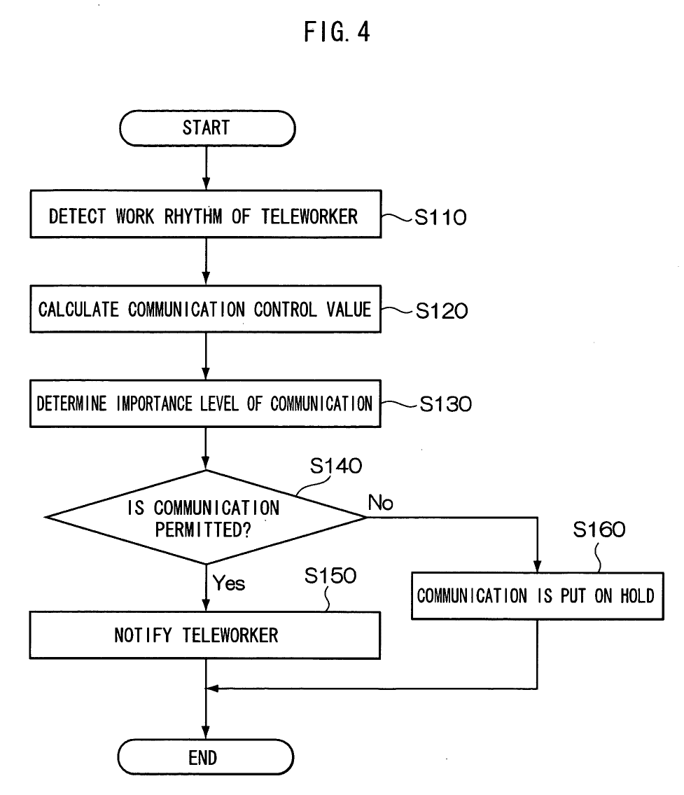

The configuration of the communication management system 1 according to the present exemplary embodiment has been explained above. In the communication management system 1 according to the present exemplary embodiment, the work rhythms of the teleworkers using the terminal devices 100 that are connected via the communication network 300 are synchronized with the standard work rhythm that the management server 200 generates. Hereinafter, communication control processing by the communication management system 1 according to the present exemplary embodiment will be explained based on FIG. 3 and FIG. 4. It should be noted that FIG. 3 is an explanatory view showing the communication control value according to the present exemplary embodiment. FIG. 4 is a flowchart showing the communication control processing according to the present exemplary embodiment.

First, processing for calculating the communication control value according to the present exemplary embodiment will be explained. As described above, the communication management system 1 according to the present exemplary embodiment synchronizes the work rhythms of the teleworkers with the standard work rhythm generated by the management server 200. The standard work rhythm is one in which the time of one day is indicated by, for example, two time periods of a concentration time period for concentrating (concentration mode) and a communication-permissible time period during which communication is permitted (normal mode). Specifically, for example, the standard work rhythm is information that from 1 p.m. to 3 p.m. is the concentration time period and time periods other than this are the communication-permissible time period, and is stored in a storage section (not shown in the drawings) of the management server 200. As shown in FIG. 3, the standard work rhythm can be configured to be a standard work rhythm signal in which, for example,. the concentration time period is indicated by “1” and the communication-permissible time period is indicated by “0”.

On the other hand, the work rhythm of the teleworker is detected by the work rhythm detection section 110 of the terminal device 100 and senses whether or not the teleworker is concentrating. Whether or not the teleworker is concentrating can be judged, for example, from a usage condition of the terminal device 100. For example, in a case where a usage amount of an input section such as a keyboard, a mouse or the like is greater than a predetermined amount, it can be judged that the teleworker is in the concentration time period. Further, in a case where an application that is used in concentrated work, such as a software development tool, is initiated and has been used for a predetermined amount of time or longer, it can be judged that the teleworker is in the concentration time period. On the other hand, time periods other than the concentration time period are judged to be the communication-permissible time period. Based on such a judgment, the work rhythm detection section 110 generates (the work rhythm of the teleworker as) a work rhythm signal in which in the concentration time period is indicated by “1” and the communication-permissible time period is indicated by “0” and sends this to the management server 200 via the work rhythm output section 120.

The communication control section 230 calculates the communication control value based on the standard work rhythm and the work rhythms of the respective teleworkers. The communication control value indicates a propriety of communication among the teleworkers. The communication management system 1 according to the present exemplary embodiment attempts to synchronize the work rhythms of the teleworkers with the standard work rhythm and, in a case where the standard work rhythm is in the concentration time period, restricts communication among all of the teleworkers so that the work rhythms of all of the teleworkers are also in the concentration time period.

On the other hand, in a case where the standard work rhythm is in the communication-permissible time period, the propriety of communication with other teleworkers is determined based on the work rhythms of the respective teleworkers. In the case of the concentration time period during which the teleworker wants to concentrate, a restriction is placed on communication with other teleworkers. In the case of the communication-permissible time period during which the teleworker is relaxing, communication with other teleworkers can be freely carried out. As a result, in the concentration time period during which the teleworker wants to concentrate, since communication requests from other teleworkers are restricted, the teleworker can work concentratedly.

For example, as shown in FIG. 3, three teleworkers are working. In the work rhythms of the three teleworkers, variations occur, and the concentration time periods and communication-permissible time periods thereof differ from each other. In the present exemplary embodiment, for example, the standard work rhythm signal and the work rhythm signals of the teleworkers form a logical sum, as discussed above. In other words, in the case where the standard work rhythm is “1”, communication of all of the teleworkers is limited to communication having a high importance level, and as shown in FIG. 3, the communication control section 230 outputs the communication control value “7”.

On the other hand, in the case where the standard work rhythm is “0”, only communication of teleworkers in the concentration time period is restricted, and the communication control section 230 outputs a value of any of the communication control values “0” through “6”. For example, in the case where all of the three teleworkers are in the communication-permissible time period, the communication control value becomes “0”. In the case where only teleworker C is in the concentration time period, the communication control value becomes “1”. In the case where only teleworker B is in the concentration time period, the communication control value becomes “2”. In the case where teleworkers B and C are in the concentration time period, the communication control value becomes “3”. In the case where only teleworker A is in the concentration time period, the communication control value becomes “4”. In the case where teleworkers A and C are in the concentration time period, the communication control value becomes “5”. In the case where teleworkers A and B are in the concentration time period, the communication control value becomes “6”.

In this manner, the propriety of communication of the respective teleworkers is judged, and the communication control value is calculated, by the communication control section 230. Using the communication control value, the communication control processing shown in FIG. 4 is carried out. The communication control processing according to the present exemplary embodiment will be explained below.

As shown in FIG. 4, in the communication control processing according to the present exemplary embodiment, first, the work rhythms of the teleworkers are detected at the respective terminal devices 100 (step S110). The detection of the work rhythms of the teleworkers is carried out by the work rhythm detection sections 110 of the respective terminal devices 100 as described above. The detected work rhythms are sent from the work rhythm output sections 120 to the management server 200.

Next, the communication control value is calculated by the management server 200 (step S120). The communication control section 230 of the management server 200 calculates the communication control value based on the standard work rhythm that has been generated by the work rhythm generation section 210 and the work rhythms of the respective teleworkers that have been input, as described above. The communication control section 230 outputs the calculated communication control value to the communication determination section 250.

Thereafter, the management server 200 determines the importance level of the communication (step S130). The processing of step S130 and subsequent steps is executed upon receiving a communication request. The determination of the importance level of the communication is carried out by the importance level determination section 240 based on a communication tool or a communication content. As for the importance level of the communication tool, for example, since a telephone call in which conversation is carried out directly with the other party has a high degree of urgency and can be considered to be a tool for transmitting important content, the importance level is set high. In contrast, since an electronic mail transmits the content thereof according to the convenience of the other party who has received it, the importance level of electronic mail is set at a moderate level. Further, chat, which is used for carrying out conversation in real time so as to engage in small talk using text or audio, is seldom used as a tool for transmitting important information. Accordingly, the importance level of chat is set low. In this manner, the importance level of the communication can be determined from the communication tool.

Further, determination of the importance level based on the communication content can be carried out, for example, from caller or sender information of a telephone call or electronic mail, a body or subject of the electronic mail, a flag indicating that the mail is important, or the like. Furthermore, in a case where a work rhythm of a sender that is requesting communication is in the concentration time period, it can be determined that the importance level of the communication is high. In this manner, the importance level of the communication determined in step S130 is output from the importance level determination section 240 to the communication determination section 250.

Then, the communication determination section 250 determines whether or not to actually permit the communication (step S140). When there is a communication request from a certain terminal device 100 to another terminal device 100 at the server transmission section 260, the communication determination section 250 receives a determination request from the server transmission section 260 and determines whether or not to actually permit the communication.

For example, it will be assumed that an electronic mail is sent from a certain terminal device 100 (for example, the terminal device 100A) to another terminal device 100 (for example, the terminal device 100B). The server transmission section 260 which has detected the sending of the electronic mail outputs to the communication determination section 250 a determination request for causing it to determine whether or not sending of the electronic mail to the terminal device 100B may be carried out. The communication determination section 250 first refers to the communication control value to determine whether or not communication to the teleworker B, for whom communication is being requested, is being restricted. For example, in a case where the communication control value is “2”, it is understood that communication is restricted to that which has a high importance level.

On the other hand, the communication determination section 250 sends to the importance level determination section 240 at least either one of information indicating the communication tool (for example, telephone, electronic mail, chat or the like) or the communication content, and causes it to determine whether or not the communication is important. The importance level determination section 240 determines the importance level of the communication based on the information that has been received from the communication determination section 250. The determination of the importance level of the communication can be carried out, for example, as described above.

At step S140, it is determined whether or not to actually permit the communication based on the communication control value and the importance level of the communication. In a case where the importance level of the requested communication is judged to be high, such as, for example, a case where it is judged that the communication is important from a subject of an electronic mail, a flag or the like, or the case of a telephone call which is a communication tool for which the importance level is considered to be high, notification of the communication request to the teleworker is carried out (step S150). It should be noted that even in the case where it is judged that the communication is not important from the communication tool or the communication content (for example, the subject of the electronic mail, the flag or the like), if it is judged from the communication control value that communication to the teleworker for which communication is being requested is not being restricted, notification of the communication request to the teleworker is carried out.

On the other hand, in the case where it is judged that the communication is not important from the communication tool or the communication content and communication to the teleworker for which communication is being requested is being restricted due to the communication control value, the communication request is put on hold. When a state in which communication is permitted is achieved, such as, for example, a case where the standard work rhythm is in the communication-permissible time period and the work rhythm of the teleworker also changes to the communication-permissible time period, notification of the communication request which has been put on hold to the teleworker is carried out. In a case where the communication request is put on hold, notification that it is being put on hold may be carried out with respect to the teleworker that is requesting the communication.

The communication control processing according to the present exemplary embodiment has been explained above. In the communication management system 1 according to the present exemplary embodiment, a configuration is provided in which only important communication is carried out in time periods designated as the concentration time period in the standard work rhythm serving as the standard, and control is carried out so as to carry out communication based on the work rhythms of the respective teleworkers during other time periods. As a result, even if communication that is not important such as, for example, an informal electronic mail, is sent to another teleworker in the concentration time period, the electronic mail is delivered after entering the communication-permissible time period. Accordingly, the teleworker can realize that the concentration time period has ended due to receiving the informal electronic mail and can initiate communication by responding to the electronic mail. In this manner, by controlling the communication, the work rhythms among the teleworkers are made to be synchronized with the standard work rhythm.

The communication management system 1 according to the present exemplary embodiment has been explained above. By intentionally providing the concentration time period and controlling communication, as in the communication management system 1 of the present exemplary embodiment, the work rhythms among the teleworkers are synchronized, and a climate that permits informal communication when the communication-permissible time period is entered is generated among the teleworkers. As a result, the conflicting states of concentrating on work and carrying out communication with others can both be achieved.

### Second Exemplary Embodiment

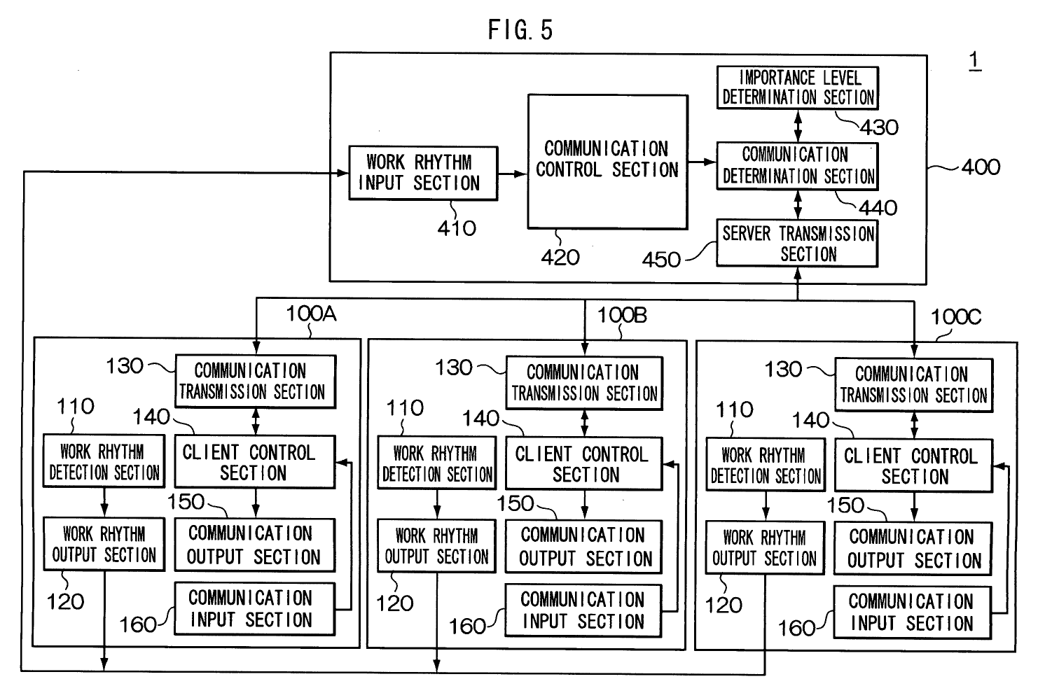

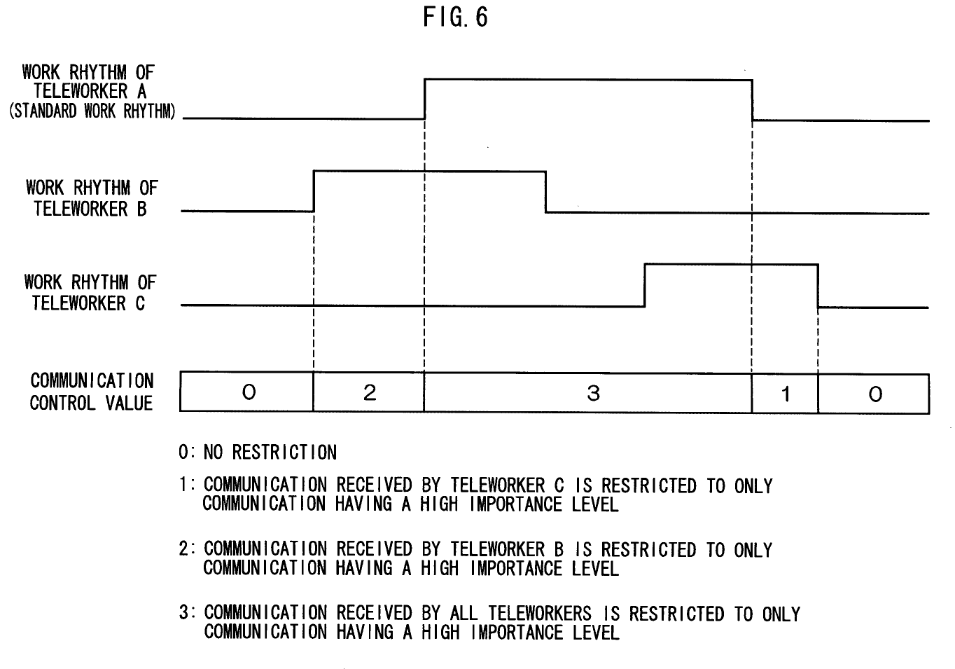

Next, the communication management system 1 according to a second exemplary embodiment of the present invention will be explained based on FIG. 5 and FIG. 6. In comparison with the first exemplary embodiment, the communication management system 1 according to the present exemplary embodiment is different in that a work rhythm of one of the teleworkers among the plural teleworkers is made to be the standard work rhythm. In the following, explanation of the communication management system 1 according to the present exemplary embodiment will be carried out mainly with respect to the differences from the first exemplary embodiment, and detailed explanation with respect to configuration and processing that are the same as in the first exemplary embodiment will be omitted. It should be noted that FIG. 5 is a block diagram showing a configuration of the communication management system 1 according to the present exemplary embodiment. FIG. 6 is an explanatory view showing a communication control operation according to the present exemplary embodiment.

As shown in FIG. 5, the communication control system 1 according to the present exemplary embodiment comprises the terminal devices 100 and a management server 400 which are connected to each other via a communication network.

As shown in FIG. 5, the terminal device 100 is constituted from the work rhythm detection section 110, the work rhythm output section 120, the communication transmission section 130, the client control section 140, the communication output section 150 and the communication input section 160, similarly as in the first exemplary embodiment. Since the configuration of the terminal device 100 and the function thereof is the same as in the first exemplary embodiment, detailed description thereof will be omitted here.

As shown in FIG. 5, the management server 400 is constituted from a work rhythm input section 410, a communication control section 420, an importance level determination section 430, a communication determination section 440 and a server transmission section 450. The management server 400 according to the present exemplary embodiment differs from the management server 200 according to the first exemplary embodiment in that it is not provided with the work rhythm generation section 210.

The work rhythm input section 410 is a functional section to which the work rhythms of the respective teleworkers are input and can be provided with a configuration that is the same as that of the work rhythm input section 220 of the first exemplary embodiment. At the work rhythm input section 410, the work rhythms of the teleworkers that have been output from the work rhythm output sections 120 of the terminal devices 100 are input, and the work rhythms that have been input are output to the communication control section 420.

The communication control section 420 is a functional section that controls communication among the terminal devices 100. The communication control section 420 sets one of the work rhythms among the plural work rhythms that have been input from the work rhythm input section 410 as the standard work rhythm, carries out comparison with the work rhythms of other teleworkers that have been input from the work rhythm input section 410, and calculates the communication control value indicating the propriety of communication among the terminal devices 100. The communication control value is output to the communication determination section 440 which will be described below.

The importance level determination section 430 is a functional section that determines the importance level of the communication and can be provided with a configuration that is the same as that of the importance level determination section 240 of the first exemplary embodiment. The importance level determination section 430 determines the importance level based on, for example, the communication tool or the communication content, similarly as in the first exemplary embodiment. The importance level determination section 430 uses this information to determine whether or not the communication that has been requested is important.

The communication determination section 440 is a functional section that determines the propriety of communication among the terminal devices 100 and can be provided with a configuration that is the same as that of the communication determination section 250 of the first exemplary embodiment. The communication determination section 440 determines whether or not to accept the communication request and carry out notification thereof to the teleworker based on the communication control value that has been input from the communication control section 420 and the importance level of the communication that has been input from the importance level determination section 430. The communication determination section 440 outputs the determination result to the server transmission section 450.

The server transmission section 450 is a functional section that carries out sending and receiving of the communication request and the communication content from the terminal devices 100. The server transmission section 450 carries out notification of the communication request and the communication content to the terminal device 100 based on the determination result of the communication determination section 440.

In the communication management system 1 according to the present exemplary embodiment, communication is controlled so as to carry out synchronization with a work rhythm of one teleworker among the plural teleworkers. For example, by setting a work rhythm of a project leader as the standard work rhythm serving as the standard, the work rhythms of the other teleworkers can be made to match the work rhythm of the project leader.

At this time, the communication control value can be determined as shown in FIG. 6. For example, in order to synchronize the work rhythms of three teleworkers, first, the work rhythms of the three teleworkers are detected. From the detected work rhythms, work rhythm signals are generated in which the concentration time period is indicated by “1” and the communication-permissible time period is indicated by “0”. Among these, the work rhythm of teleworker A is made to be the standard work rhythm. Then, the communication control value is calculated from these work rhythms. In the present exemplary embodiment, similarly as in the first exemplary embodiment, for example, a logical sum of the standard work rhythm signal and the work rhythm signals of the other teleworkers is found, and the communication control value is calculated.

For example, as shown in FIG. 6, in a case where the work rhythm of teleworker A serving as the standard work rhythm is “1”, the communication of all of the teleworkers is limited to that which has a high importance level, and the communication control section 420 outputs the communication control value “3”. On the other hand, in a case where the standard work rhythm is “0”, only the communication of teleworkers in the concentration time period is restricted, and the communication control section 420 outputs a value of any of the communication control values “0” through “2”. For example, in a case where all of the three teleworkers are in the communication-permissible time period, the communication control value becomes “0”. Further, in a case where only teleworker C is in the concentration time period, the communication control value becomes “1”. In a case where only teleworker B is in the concentration time period, the communication control value becomes “2”.

In this manner, the propriety of communication of the respective teleworkers is judged, and the communication control value is calculated, by the communication control section 420. Using the communication control value, the communication control processing shown in FIG. 4 is carried out, similarly as in the first exemplary embodiment. It should be noted that explanation with respect to the communication control processing is omitted.

The communication management system 1 according to the present exemplary embodiment has been explained above. According to the communication management system 1 of the present exemplary embodiment, the work rhythm of a certain teleworker is made to be the standard work rhythm, and the work rhythms of the other teleworkers are synchronized with the work rhythm of the one teleworker. In other words, the standard work rhythm changes according to the status of the teleworker. In this manner, it is possible to synchronize the work rhythms of teleworkers concerned with a project to the dynamically changing status of the project.

### Third Exemplary Embodiment

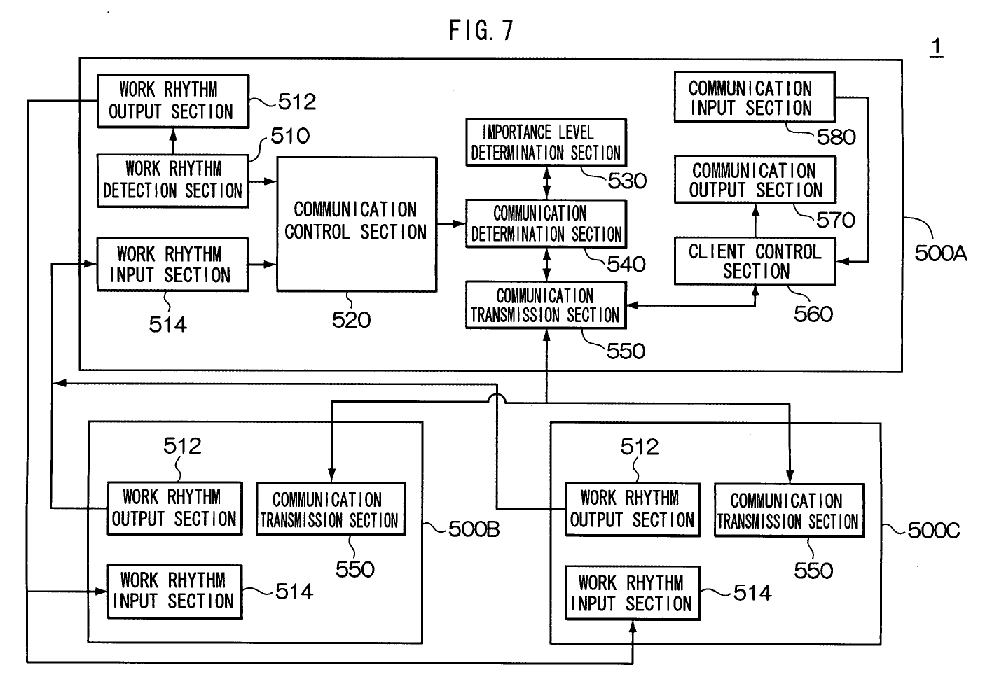

Next, the communication management system 1 according to a third exemplary embodiment of the present invention will be explained based on FIG. 7. In the communication management system 1 of the present exemplary embodiment, there is no management server, and control of communication with other terminal devices is carried out within each of the terminal devices. In the following, explanation will be mainly carried out with respect to configurations, functions and processing that are distinctive in the communication management system 1 according to the present exemplary embodiment, and detailed explanation with respect to configurations, functions, processing and the like that are the same as in the exemplary embodiments described above will be omitted. It should be noted that FIG. 7 is a block diagram showing the configuration of the communication management system 1 according to the present exemplary embodiment.

The communication management system 1 according to the present exemplary embodiment comprises, for example, three terminal devices 500 (500A, 500B and 500C) connected to each other via a communication network. As shown in FIG. 7, each terminal device 500 comprises a work rhythm detection section 510, a work rhythm output section 512, a work rhythm input section 514, a communication control section 520, an importance level determination section 530, a communication determination section 540, a communication transmission section 550, a client control section 560, a communication output section 570 and a communication input section 580.

The work rhythm detection section 510 is a functional section that detects a work rhythm of a teleworker using the terminal device 500 and may be provided with a configuration that is the same as that of the work rhythm detection section 110 of the first exemplary embodiment. The work rhythm detection section 510 detects the work rhythm of the teleworker at a predetermined interval or at a predetermined timing and outputs the detected work rhythm to the work rhythm output section 512. The work rhythm output section 512 outputs the work rhythm that has been input from the work rhythm detection section 510, to the other terminal devices 500. Further, the work rhythm input section 514 is a functional section to which the work rhythms of the teleworkers that have been detected at the other terminal devices 500 are input.

The communication control section 520 is a functional section that controls communication among the terminal devices 500 and may be provided with a configuration that is the same as that of the communication control section 230 of the first exemplary embodiment. The communication control section 520 compares the work rhythm that is input from its own work rhythm detection section 510 and the work rhythms of the respective teleworkers that are input from the work rhythm input section 514 and calculates the communication control value indicating the propriety of communication among the terminal devices 500. The calculated communication control value is output to the communication determination section 540 which will be described below.

The importance level determination section 530 is a functional section that determines the importance level of the communication and may be provided with a configuration that is the same as that of the importance level determination section 240 of the first exemplary embodiment. The importance level determination section 530 determines the importance level based on, for example, the communication tool or the communication content. The importance level determination section 530 uses this information to determine whether or not the requested communication is important.

The communication determination section 540 is a functional section that determines the propriety of communication among the terminal devices 500 and may be provided with a configuration that is the same as that of the communication determination section 250 of the first exemplary embodiment. The communication determination section 540 determines whether or not to accept a communication request and carry out notification thereof to the teleworker based on the communication control value that has been input from the communication control section 520 and the importance level of the communication that has been input from the importance level determination section 530. The communication determination section 540 outputs the determination result to the communication transmission section 550.

The communication transmission section 550 is a functional device that carries out sending and receiving of the communication request and the communication content from another terminal device 500 and can be provided with a configuration that is equipped with the functions of the communication transmission section 130 and the server transmission section 260 of the first exemplary embodiment. The communication transmission section 550 sends the corresponding information to the client control section 560 in order to carry out notification of the communication request and the communication content to the teleworker using its own terminal device 500, based on the determination result of the communication determination section 540. Further, when the teleworker requests communication with respect to a teleworker using another terminal device 500, the communication transmission section 550 sends the communication request to the another terminal device 500.

The client control section 560 is a functional section that controls sending and receiving of communication by a communication tool and can be provided with a configuration that is the same as that of the client control section 140 of the first exemplary embodiment. The client control section 560 outputs, from the communication transmission section 550 to the another terminal device 500, the communication request to the another terminal device 500, which has been input from the communication input section 580 which will be described below. Further, a communication request that has been sent from another terminal device 500 is input to the client control section 560 via the communication transmission section 550. The communication request which has been input is output from the communication output section 570 which will be described below.

The communication output section 570 is a functional section that carries out notification of the communication request from the another terminal device 500 and the communication content, to the teleworker. For the communication output section 570, for example, a display, a speaker or the like can be used.

The communication input section 580 is a functional section for inputting the communication request and inputting the communication content in the case where the teleworker wishes to carry out communication with a teleworker using another terminal device 500. For the communication input section 580, for example, a keyboard, a mouse, a microphone or the like can be used.

The configuration of the terminal devices 500 constituting the communication management system 1 of the present exemplary embodiment has been explained above. In the terminal devices 500 according to the present exemplary embodiment, determination of whether or not to carry out notification of a communication request to the teleworker using its own terminal device 500 is carried out at the respective terminal devices 500. In other words, the respective terminal devices 500 can retain a common standard work rhythm in advance, or can possess information of a teleworker that is set as the standard work rhythm and obtain the standard work rhythm based on the information. Then, determination of whether or not to carry out notification of a communication request received from another terminal device 500 to the teleworker using its own terminal device 500 is carried out based on the communication control value which has been calculated at the communication control section 520 from the standard work rhythm and the work rhythm of the teleworker, and the importance level of the communication which has been determined by the importance level determination section 530.

The communication management system 1 according to the present exemplary embodiment has been described above. According to the communication management system 1 of the present exemplary embodiment, since the respective terminal devices 500 are equipped with the functional sections for carrying out communication control, communication among the respective terminal devices 500 can be controlled, even though a management server is not provided as in the first and second exemplary embodiments.

In the foregoing, preferable exemplary embodiments of the present invention have been described in detail with reference to the attached drawings, but the present invention is not limited to these examples. It will be clear to those having ordinary skill in the technical field to which the invention belongs that various altered examples and modified examples can be conceived of within the category of the technical ideas recited in the claims, and it will be naturally understood that these also fall within the technical scope of the present invention.

For example, in the above exemplary embodiments, although the communication control value is made to be a logical sum of the work rhythm signals, the present invention is not limited to these examples, and the communication control value can be generated by other computations.

Further, in the above exemplary embodiments, although the work rhythm is expressed by a binary value, the present invention is not limited to these examples, and, for example, this may be a multiple value. In this case, the weighting of the work rhythm serving as the standard is made to be larger, and the weighting of the work rhythms of the other teleworkers is made to be smaller. As a result, all of the work rhythms can be made to match with the standard work rhythm even more.

Moreover, in the above exemplary embodiments, although the importance level of the communication is determined according to the communication tool such as telephone, electronic mail or chat, or the communication content, the present invention is not limited to these examples. For example, information (e.g., organizational attribute information or the like) obtained by analyzing a history of a mail server can be utilized to determine whether an electronic mail is a formal electronic mail or an informal electronic mail. Further, the importance level is not limited to being expressed by a binary value and may be a multiple value.

Embodiments of the present invention are described above, but the present invention is not limited to the embodiments as will be clear to those skilled in the art.

According to an aspect of the invention, there is provided a terminal device, plural terminal devices being connected to each other via a communication network, the terminal device comprising: a work rhythm detection section that detects a work rhythm of a user based on a usage condition of the terminal device; a communication control section that compares the detected work rhythm and a standard work rhythm serving as a standard of the work rhythm of the user and calculates a communication control value indicating a propriety of communication among the terminal devices; and a communication determination section that determines whether or not to carry out notification of a communication request from another terminal device based on the communication control value.

According to the present invention, whether or not communication with other teleworkers is restricted is determined based on the communication control value calculated from the standard work rhythm and the work rhythms of the users. The communication control value is set so that the work rhythms of the users are synchronized with the standard work rhythm. By controlling the communication among the users based on such a communication control value, the workers can be caused to carry out work according to a work rhythm that is based on the standard work rhythm, and the timing at which communication is carried out can be synchronized.

Here, an importance level determination section that determines an importance level of the communication request from the another terminal device can be further provided. At this time, the communication determination section determines whether or not to carry out notification of the communication request from the another terminal device based on the communication control value and the importance level of the communication. As a result, the work rhythm of the user can be prevented from being disturbed, and important communication requests can be transmitted to the user immediately.

Further, the importance level determination section may determine the importance level of the communication request based on a classification of a communication tool. Moreover, when the communication tool is electronic mail, the communication control section may change the number of electronic mail notifications that are notified, based on the communication control value. Further, the importance level determination section may determine the importance level of the communication request based on the communication content.

The communication control section may be configured so as to output the communication control value, which restricts communication among all of the terminal devices, when the standard work rhythm indicates a concentration mode in which work is concentratedly carried out (the users are concentrated in work). For example, the communication control section can calculate the communication control value based on its own work rhythm when the standard work rhythm indicates a normal mode other than the concentration mode.

Further, the standard work rhythm may be a work rhythm of a user using any one of the terminal devices among the plural terminal devices. As a result, the standard work rhythm can be changed in accordance with a condition of the user.

Further, according to an aspect of the invention, there is provided a management server that is connected to plural terminal devices via a communication network and manages communication among the terminal devices, the management server comprising: a work rhythm input section to which work rhythms of users, which are detected based on usage conditions of the respective corresponding terminal devices, are input from the respective terminal devices; a communication control section that compares the input work rhythms and a standard work rhythm serving as a standard of the work rhythms of the users and calculates a communication control value indicating a propriety of communication among the terminal devices; and a communication determination section that determines whether or not to carry out notification of a communication request to a terminal device for which communication has been requested from another terminal device, based on the communication control value.

Here, the management server can be further provided with a work rhythm generation section that generates the standard work rhythm.

Furthermore, according to an aspect of the invention, there is provided a communication management system in which plural terminal devices and a management server that manages communication among the plural terminal devices are connected via a communication network, each terminal device comprising: a work rhythm detection section that detects a work rhythm of a user based on a usage condition of the terminal device; and a work rhythm output section that outputs the detected work rhythm to the management server, the management server comprising: a work rhythm input section to which the work rhythms are input from the respective terminal devices; a communication control section that compares the input work rhythms and a standard work rhythm serving as a standard of the work rhythms of the users and calculates a communication control value indicating a propriety of communication among the terminal devices; and a communication determination section that determines whether or not to carry out notification of a communication request to a terminal device for which communication has been requested from another terminal device, based on the communication control value.

As described above, according to the present invention, a terminal device, a management server and a communication management system can be provided in which it is possible to control communication among teleworkers to synchronize the work rhythms of the respective teleworkers.

What is claimed is:

1. A terminal device, a plurality of the terminal devices being connected to each other via a communication network, the terminal device comprising:
a work rhythm detection section that detects a work rhythm of a user based on a usage condition of the terminal device;
a communication control section that compares the detected work rhythm and a standard work rhythm serving as a standard of the work rhythm of the user and calculates a communication control value indicating a propriety of communication among the terminal devices; and
a communication determination section that determines whether or not to carry out notification of a communication request from another terminal device based on the communication control value.

2. The terminal device according to claim 1, further comprising an importance level determination section that determines an importance level of the communication request from the another terminal device, wherein the communication determination section determines whether or not to carry out notification of the communication request from the another terminal device based on the communication control value and the importance level of the communication.

3. The terminal device according to claim 2, wherein the importance level determination section determines the importance level of the communication request based on a classification of a communication tool.

4. The terminal device according to claim 3, wherein the communication tool is electronic mail, and the communication control section changes the number of electronic mail notifications that are notified, based on the communication control value.

5. The terminal device according to claim 3, wherein the communication tool includes at least one of telephone, electronic mail or chat.

6. The terminal device according to claim 2, wherein the importance level determination section determines the importance level of the communication request based on a communication content.

7. The terminal device according to claim 6, wherein the communication content includes at least one of caller information of a telephone call, sender information of an electronic mail, a body of the electronic mail, a subject of the electronic mail, or a flag indicating that the electronic mail is important.

8. The terminal device according to claim 1, wherein the communication control section outputs the communication control value, which restricts communication among all of the terminal devices, when the standard work rhythm indicates a concentration mode in which work is concentratedly carried out.

9. The terminal device according to claim 8, wherein the communication control section calculates the communication control value based on the detected work rhythm of its own terminal device, when the standard work rhythm indicates a normal mode other than the concentration mode.

10. The terminal device according to claim 8, further comprising an importance level determination section that determines an importance level of the communication request from the another terminal device, wherein the communication control section restricts the communication by carrying out notification of only a communication request for which the importance level of the communication request is high, when the standard work rhythm indicates the concentration mode.

11. The terminal device according to claim 8, wherein the concentration mode is indicated by 1, a normal mode other than the concentration mode is indicated by 0, and the communication control section calculates the communication control value by calculating a logical sum of the standard work rhythm and the detected work rhythm of its own terminal device.

12. The terminal device according to claim 1, wherein the standard work rhythm is a work rhythm of a user using any one of the terminal devices among the plurality of terminal devices.

13. The terminal device according to claim 1, wherein each of the plurality of terminal devices stores a common standard work rhythm in advance.

14. A management server that is connected to a plurality of terminal devices via a communication network and manages communication among the terminal devices, the management server comprising:
a work rhythm input section to which work rhythms of users, which are detected based on usage conditions of the respective corresponding terminal devices, are input from the respective terminal devices;
a communication control section that compares the input work rhythms and a standard work rhythm serving as a standard of the work rhythms of the users and calculates a communication control value indicating a propriety of communication among the terminal devices; and
a communication determination section that determines whether or not to carry out notification of a communication request to a terminal device for which communication has been requested from another terminal device, based on the communication control value.

15. The management server according to claim 14, further comprising a work rhythm generation section that generates the standard work rhythm.

16. The management server according to claim 14, wherein the standard work rhythm is a work rhythm of a user using any one of the terminal devices among the plurality of terminal devices.

17. A communication management system in which a plurality of terminal devices and a management server that manages communication among the plurality of terminal devices are connected via a communication network,
each terminal device comprising:
a work rhythm detection section that detects a work rhythm of a user based on a usage condition of the terminal device; and
a work rhythm output section that outputs the detected work rhythm to the management server,
the management server comprising:
a work rhythm input section to which the work rhythms are input from the respective terminal devices;
a communication control section that compares the input work rhythms and a standard work rhythm serving as a standard of the work rhythms of the users and calculates a communication control value indicating a propriety of communication among the terminal devices; and
a communication determination section that determines whether or not to carry out notification of a communication request to a terminal device for which communication has been requested from another terminal device, based on the communication control value.
